(19) United States
(12) Patent Application Publication
(10) Pub. No.: US 2024/0122807 A1
(43) Pub. Date: Apr. 18, 2024

(54) A TAMPING DEVICE FOR CAPSULE FILLING MACHINES

(71) Applicants: SCI-TECH CENTRE, Mumbai (IN); ACG PAM PHARMA TECHNOLOGIES PVT. LTD, Mumbai (IN)

(72) Inventors: Karan SINGH, Mumbai (IN); Hans-Werner BONGERS, Mumbai (IN); James D'SILVA, Mumbai (IN); Shashank PAWAR, Mumbai (IN)

(73) Assignees: SCI-TECH CENTRE, Mumbai (IN); ACG PAM PHARMA TECHNOLOGIES PVT. LTD, Mumbai (IN)

(21) Appl. No.: 18/263,868

(22) PCT Filed: Jan. 28, 2022
(86) PCT No.: PCT/IN2022/050067

§ 371 Date: Aug. 1, 2023

(30) Foreign Application Priority Data
Feb. 1, 2021 (IN) 202121004362

(51) Int. Cl. A61J 3/07

(52) U.S. Cl. CPC A61J 3/074; A61J 2200/70

(57) ABSTRACT

A tamping device for capsule filling machines is disclosed. The device includes a dosing disc having at least one dosing chamber adapted to be filled with a material which is to be filled in a capsule. The device includes at least one piston adapted to be moved within the at least one dosing chamber to perform the tamping operation on the material. The device includes at least one slider disposed below the dosing disc and adapted to abut the dosing disc. The at least one slider is adapted to support the material within the at least one dosing chamber to perform the tamping operation. The device includes a support pad movably disposed beneath the at least one slider and adapted to be moved towards the at least one slider.

### FIELD OF THE INVENTION

The present disclosure relates to capsule filling machines and more particularly, to a device for performing a tamping operation in a capsule filling machine.

### BACKGROUND

Generally, capsule filling machines are employed in industries, such as pharmaceutical industries, for filling drugs within a capsule. In the capsule filling machines, various sub-units are provided for performing different operations, such as opening a capsule, filling drugs within the capsule, and closing the capsule Usually, for filling drugs within the capsule, a tamping unit is provided that is adapted to form a slug of a material, i.e., the drug, to be inserted within the capsule. The tamping unit is provided to perform consecutive tamping operations on the material to form the slug which is inserted within the capsule for consumption. However, during such tamping operations, the material used for forming the slug usually gets spilled in the tamping unit. This leads to wastage of a substantial amount of the material which further results in an overall increase of cost associated with drug filling operation of the capsule. Further, spillage of the material during the tamping operations may also affect the efficient operation of various sub-components of the tamping unit and the capsule filling machine. This results in a substantial reduction in the overall service life of the capsule filling machine.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

In an embodiment of the present disclosure, a device for performing tamping operation in a capsule filling machine. The device includes a dosing disc having at least one dosing chamber adapted to be filled with a material which is to be filled in a capsule. Further, the device includes at least one piston adapted to be moved within the at least one dosing chamber to perform the tamping operation on the material to form a slug. The at least one piston applies a tamping force on the material filled within the at least one dosing chamber. The device includes at least one slider disposed below the dosing disc and adapted to abut the dosing disc. The at least one slider is adapted to support the material within the at least one dosing chamber to perform the tamping operation. Further, the device includes a support pad movably disposed beneath the at least one slider and adapted to be moved towards the at least one slider. The support pad is adapted to abut the at least one slider to distribute the tamping force applied by the at least one piston on the material. The device includes an actuation unit coupled to the support pad and adapted to move the support pad towards the at least one slider. The actuation unit moves the support pad to abut the at least one slider.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram depicting a capsule filling machine, according to an embodiment of the present disclosure;

FIG. 2 illustrates a partial perspective view of a device to perform a tamping operation in the capsule filling machine, according to an embodiment of the present disclosure;

FIGS. 3a-3f illustrate partial perspective views of the device depicting the tamping operation at different tamping stations of the device, according to an embodiment of the present disclosure;

FIGS. 4a-4b illustrate partial top views of the device depicting a plurality of sliders at different tamping stations of the device, according to an embodiment of the present disclosure;

FIGS. 4c-4d illustrate partial top views of the device depicting an arrangement of a dosing disc with respect to the plurality of sliders, according to an embodiment of the present disclosure;

FIG. 5 illustrate a partial perspective view of the device depicting a support pad and an actuation unit, according to an embodiment of the present disclosure;

FIG. 6 illustrate a partial cross sectional view of the device depicting the support pad and the actuation unit, according to an embodiment of the present disclosure;

FIG. 7 illustrates a perspective view of a drive pulley coupled to a lead-screw mechanism of the actuation unit, according to an embodiment of the present disclosure;

FIG. 8 illustrate a partial top view of the device depicting a pulley mechanism, according to an embodiment of the present disclosure;

FIGS. 9a-9f illustrate partial perspective views of the device depicting the tamping operation at different tamping stations of the device, according to an embodiment of the present 25 disclosure; and

FIGS. 10a and 10b illustrate a rear view and a side view, respectively, of the device depicting a sensing unit, according to an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The system, methods, and examples provided herein are illustrative only and not intended to be limiting.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and does not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfil the requirements of uniqueness, utility and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

Embodiments of the present invention will be described below in detail with reference to the accompanying drawings.

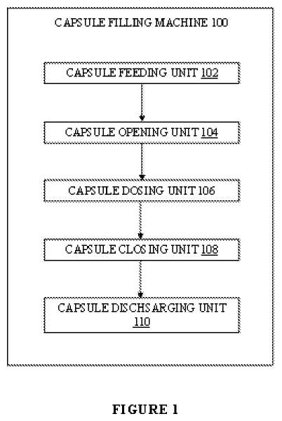

FIG. 1 illustrates a block diagram depicting a capsule filling machine 100, according to an embodiment of the present disclosure. The capsule filling machine 100 may be deployed in industries, such as pharmaceutical industry, for filling various types of drugs within capsules. In the illustrated embodiment, the capsule filling machine 100 may include, but is not limited to, a capsule feeding unit 102, a capsule opening unit 104, a capsule dosing unit 106, and a capsule closing unit 108, and a capsule discharging unit 110. The capsule feeding unit 102 may be adapted to feed a plurality of capsules in the capsule filling machine 100. Subsequently, the capsule feeding unit 102 may be adapted to align each of the plurality of capsules in the capsule opening unit 104.

In an embodiment, the capsule opening unit 104 may be adapted to open each of the plurality of capsules by separating a cap portion from a body portion of each of the plurality of capsules. Further, the body portion of each of the plurality of capsules may be moved to the capsule dosing unit 106 adapted to fill the body portion with the drug. In an embodiment, the capsule dosing unit 106 may be adapted to performs a tamping operation on the drug to form a slug which is to be transferred within the body portion of each of the plurality of capsules.

The capsule dosing unit 106 may interchangeably be referred to as one of the tamping unit 106 and the device 106, without departing from the scope of the present disclosure. Constructional and operational details of the device 106 are explained in detail in the subsequent sections of the present disclosure. Further, the body portion and the cap portion may be moved to the capsule closing unit 108 adapted to merge the body portion with the cap portion to form a capsule. Subsequently, each of the plurality of capsules filled with the slug may be moved to the capsule discharging unit 110 adapted to eject the plurality of capsules from the capsule filling machine 100.

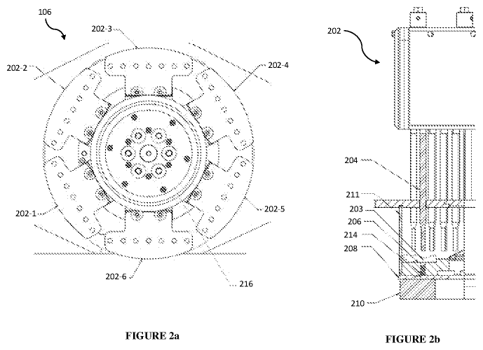

FIGS. 2a and 2b illustrate a partial top view and a partial perspective view, respectively, of the device 106 to perform the tamping operation in the capsule filling machine 100, according to an embodiment of the present disclosure. Referring to FIGS. 2a and 2b, in the illustrated embodiment, the device 106 may include a plurality of tamping stations 202 distributed in a circular arrangement to successively perform the tamping operation and subsequently, eject the slug from the device 106 in the body portion of the capsule. Constructional and operational details of each of the plurality of tamping stations 202 are explained in the subsequent sections of the present disclosure.

The plurality of tamping stations 202 may interchangeably be referred to as the tamping stations 202, without departing from the scope of the present disclosure. Further, the tamping stations 202 may individually be referred to as the tamping station 202-1, the tamping station 202-2, the tamping station 202-3, . . . , and the tamping station 202-n. In the illustrated embodiment, the device 106 includes six tamping stations 202 distributed in the circular arrangement. The present disclosure is explained with respect to the device 106 having six tamping stations 202. However, it should be appreciated by a person skilled in the art that it should not be construed as limiting, and the device 106 may include more than six tamping stations 202 or less than six tamping stations 202, without departing from the scope of the present disclosure.

Referring to FIG. 2b, each of the tamping stations 202 of the device 106 may include, but is not limited to, at least one piston 204 adapted to reciprocate in a vertical direction to perform the tamping operation. In the illustrated embodiment, each of the tamping stations 202 may include a plurality of pistons 204 to simultaneously perform multiple tamping operations at each of the plurality of tamping stations 202. Each of the plurality of pistons 204 may be adapted to reciprocate to a pre-defined distance, interchangeably referred to as the piston stroke, in the vertical direction.

In the illustrated embodiment, the plurality of pistons 204 may include a set of pistons 204-1, a set of pistons 204-2, a set of pistons 204-3, a set of pistons 204-4, a set of pistons 204-5, and a set of pistons 204-6. In an embodiment, the set of pistons 204-1, the set of pistons 204-2, the set of pistons 204-3, the set of pistons 204-4, the set of pistons 204-5, and the set of pistons 204-6 may interchangeably be referred to as the set of pistons 204-1, 204-2, 204-3, 204-4 204-5, 204-6, without departing from the scope of the present disclosure. The set of pistons 204-1, 204-2, 204-3, 204-4 204-5, 204-6 may be disposed at the tamping stations 202-1, 202-2, 202-3, 202-4, 202-5, 202-6, respectively.

As mentioned earlier, each of the set of pistons 204-1, 204-2, 204-3, 204-4, 204-5, 204-6 may be adapted to reciprocate in the vertical direction. In an embodiment, the piston stroke corresponding to the set of pistons 204-1, 204-2, 204-3, 204-4, 204-5, 204-6 may gradually reduce from the tamping station 202-1 to the tamping station 202-5 of the device 106. In particular, the piston stroke corresponding to the set of pistons 204-2 at the tamping station 202-2 may be less than the piston stroke corresponding to the set of pistons 204-1 at the tamping station 202-1. Similarly, the piston stroke corresponding to the set of pistons 204-3 at the tamping station 202-3 may be less than the piston stroke corresponding to the set of pistons 204-2 at the tamping station 202-2. Further, the piston stroke corresponding to the set of pistons 204-4 at the tamping station 202-4 may be less than the piston stroke corresponding to the set of pistons 204-3 at the tamping station 202-3.

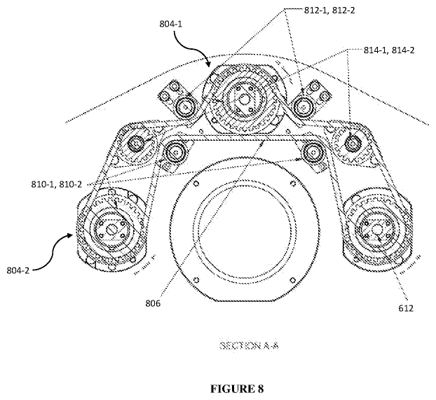

Further, the device 106 may include, but is not limited to, a dosing disc 206, at least one slider 208, a support pad 210, a dosing disc cover 211, and an actuation unit 212 (shown in FIG. 6). In the illustrated embodiment, the device 106 may include a plurality of sliders 208 disposed corresponding to the tamping stations 202 of the device 106. The plurality of sliders 208 may be movably disposed below the dosing disc 206. Further, the support pad 210 may be movably disposed below the plurality of sliders 208. The support pad 210 may be adapted to be moved in the vertical direction by the actuation unit 212 which is explained in detail in the later sections of the present disclosure.

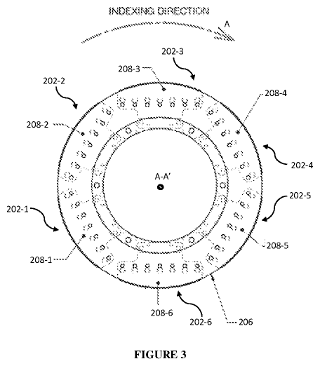

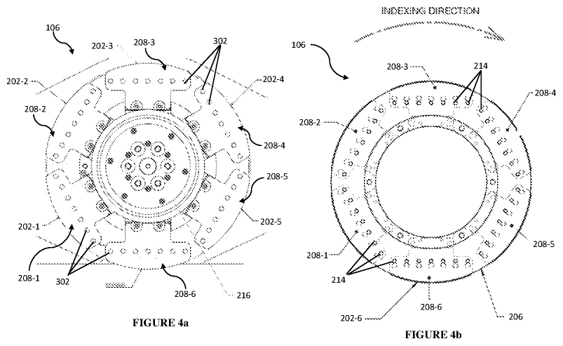

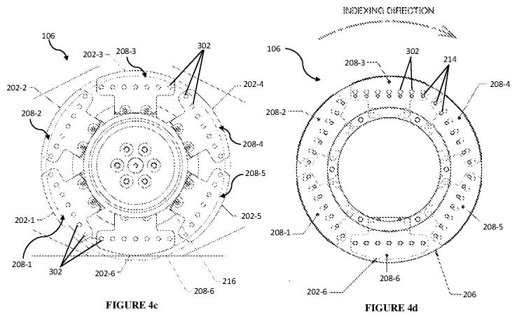

FIG. 3 illustrate a partial top view of the device 106 depicting arrangement of the plurality of sliders 208 on the dosing disc 206 of the device 106, according to an embodiment of the present disclosure. In an embodiment, the dosing disc 206 may be adapted to rotate about a central axis A-A′ of the dosing disc 206. Referring to FIG. 2b and FIG. 3, the rotation of the dosing disc 206 may be indicated by an arrow A. The dosing disc 206 may include at least one dosing chamber 214 adapted to be filled with a material 203, such as the drug, which is to be filled in the capsule in a form of the slug. The least one piston 204 may be adapted to be moved within the at least one dosing chamber 214 to perform the tamping operation on the material to form the slug 203. The at least one piston 204 may apply a tamping force on the material filled within the at least one dosing chamber 214 to form the slug 203.

Referring to FIG. 3, in the illustrated embodiment, the dosing disc 206 may include a plurality of dosing chambers 214 adapted to be filled with the material. The plurality of dosing chambers 214 may include a set of dosing chambers 214-1, a set of dosing chambers 214-2, a set of dosing chambers 214-3, a set of dosing chambers 214-4, a set of dosing chambers 214-5, and a set of dosing chambers 214-6. In an embodiment, the set of dosing chambers 214-1, the set of dosing chambers 214-2, the set of dosing chambers 214-3, the set of dosing chambers 214-4, the set of dosing chambers 214-5, and the set of dosing chambers 214-6 may collectively be referred to as the set of dosing chambers 214-1, 214-2, 214-3, 214-4, 214-5, 214-6.

Each of the set of dosing chambers 214-1, 214-2, 214-3, 214-4, 214-5, 214-6 may be aligned with each of the tamping stations 202 of the device 106. During the tamping operation, at an instance, the set of pistons 204-1, 204-2, 204-3, 204-4, 204-5, 204-6 may perform the tamping operation on the material filled in the set of dosing chambers 214-1, 214-2, 214-3, 214-4, 214-5, 214-6, respectively, by applying the tamping force on the material. As explained earlier, the piston stroke corresponding to the set of pistons 204-1, 204-2, 204-3, 204-4, 204-5, 204-6 may gradually reduce from the tamping station 202-1 to the tamping station 202-5 of the device 106. Therefore, in such an instance, the tamping force applied by the set of pistons 204-1 on the material filled in the set of dosing chambers 214-1 may be higher than the tamping force applied by the subsequent set of pistons on the material filled in the set of dosing chambers 214-2, 214-3, 214-4, 214-5, 214-6.

Referring to FIG. 3, in the illustrated embodiment, the device 106 may include a plurality of sliders 208 disposed in a circular arrangement below the dosing disc 206. In particular, each of the plurality of sliders 208 may be movably disposed below the dosing disc 206. Each of the plurality of sliders 208 may be adapted to be moved radially with respect to the central axis A-A′ of the dosing disc 206. The at least one slider is adapted to be moved between a retracted position and an extended position with respect to the central axis A-A′ of the dosing disc 206. Each of the plurality of sliders 208 may be adapted to abut the dosing disc 206.

The plurality of sliders 208 may be adapted to support the material within the set of dosing chambers 214-1, 214-2, 214-3, 214-5, 214-6 to perform the tamping operation. In an embodiment, the plurality of sliders 208 may be aligned with the tamping stations 202 of the device 106. Each of the plurality of sliders 208 may include a plurality of holes 302 adapted to allow ejection of the slug from the dosing disc 206. Each of the plurality of holes 302 may be offset from the at least one dosing chamber 214 of the dosing disc 206.

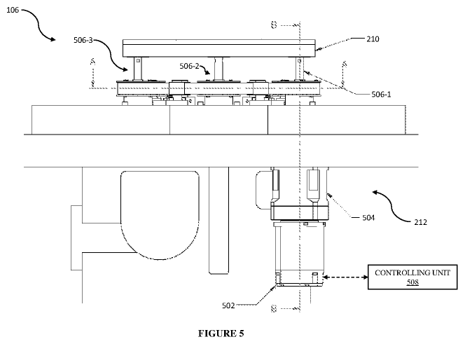

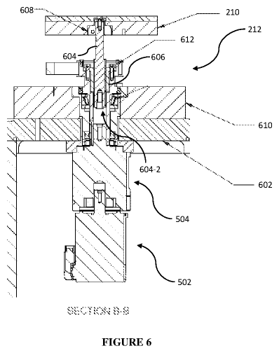

FIGS. 4a-4d illustrate partial top views of the device 106 depicting the plurality of sliders 208 and the dosing disc 206 of the device 106, according to an embodiment of the present disclosure. As mentioned earlier, each of the plurality of sliders 208 may be adapted to move between the extended position and the retracted position. Referring to FIG. 4a and FIG. 4b, in the extended position, each of the plurality of holes 302 may be offset from the at least one dosing chamber 214 of the dosing disc 206. Each of the plurality of sliders 208 may include a top surface and a bottom surface distal to the top surface.

Each of the plurality of sliders 208 may be movably positioned below the dosing disc 206 in a manner that the top surface faces towards the dosing disc 206. The top surface of each of the plurality sliders 208 may be adapted to support the material within the at least one dosing chambers 214 during the tamping operation. Each of the plurality of sliders 208 may be adapted to remain in the extended position when the at least one piston 204 moves within the at least one dosing chamber 214 to perform the tamping operation.

Referring to FIG. 4c and FIG. 4d, in the retracted position, at least one of the plurality of holes 302 may align with the at least one dosing chamber 214 of the dosing disc 206. In the extended position, the slug may be ejected from the at least one dosing chamber 214 through one of the plurality of holes 302. In the retracted position, the at least one piston 204 moves in a downward direction to push the slug through the at least one dosing chamber 214 and subsequently, through the at least one of the plurality of holes 302 aligned with the at least one dosing chamber 214.

In the illustrated embodiment, referring to FIG. 3 and FIGS. 4a-4d, the plurality of sliders 208 may include a slider 208-1, a slider 208-2, a slider 208-3, a slider 208-4, a slider 208-5, and a slider 208-6, without departing from the scope of the present disclosure. The slider 208-1, the slider 208-2, the slider 208-3, the slider 208-4, the slider 208-5, and the slider 208-6 may interchangeably be referred to as the sliders 208-1, 208-2, 208-3, 208-4, 208-5, 208-6. Referring to FIG. 3, the sliders 208-1, 208-2, 208-3, 208-4, 208-5, 208-6 may be aligned with the tamping stations 202-1, 202-2, 202-3, 202-4, 202-5, 202-6.

The sliders 208-1, 208-2, 208-3, 208-4, 208-5, 208-6 may be disposed corresponding to the set of dosing chamber 214-1, 214-2, 214-3, 214-4, 214-5, 214-6, respectively. In the illustrated embodiment, the plurality of holes 302 of each of the sliders 208-1, 208-2, 208-3, 208-4, 208-5, 208-6 may be offset from each of the set of dosing chambers 214-1, 214-2, 214-3, 214-4, 214-5, 214-6. Operational details of the sliders 208-1, 208-2, 208-3, 208-4, 208-5, 208-6 are explained in detail in the subsequent section of the present disclosure.

Referring to FIG. 4c and FIG. 4d, in the illustrated embodiment, the tamping operation may be performed at the tamping stations 202-1, 202-2, 202-3, 202-4, 202-5 of the device 106. Further, the slug may be ejected from the device 106 at the tamping station 202-6 of the device. At the tamping station 202-6, the slider 208-6 may be adapted to move to the retracted position to align the plurality of holes 302 with the set of dosing chambers 214-6 at the tamping station 202-6. The set of piston 204-6 at the tamping station 202-6 may move in the downward direction to push the slug from the set of dosing chambers 214-6 and subsequently, eject the slug through the plurality of holes 302 of the slider 208-6.

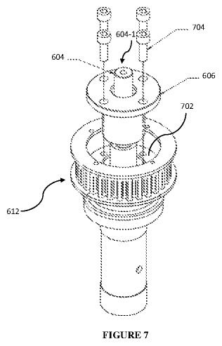

FIG. 5 illustrates a partial perspective view of the device 106 depicting the support pad 210 and the actuation unit 212, according to an embodiment of the present disclosure. Referring to FIG. 5, in the illustrated embodiment, the support pad 210 may be movably disposed beneath the at least one slider 208. The support pad 210 may be adapted to be moved towards the at least one slider 208. The support pad 210 may be adapted to be moved between a top position and a bottom position with respect to the at least one slider 208. The support pad 210 may be adapted to abut the at least one slider 208 to distribute the tamping force applied by the at least one piston 204 on the material.

For instance, the support pad 210 may abut the at least one slider 208, when the support pad 210 is moved to the top position. As mentioned earlier, the dosing disc 206 may be adapted to rotate along the central axis A-A′ of the dosing disc 206. In particular, the dosing disc 206 may be adapted to rotate along the central axis A-A′ of the dosing disc 206 to align the set of dosing chambers 214-1, 214-2, 214-3, 214-4, 214-5, 214-6 with the set of pistons 204-1, 204-2, 204-3, 204-4, 204-5, 204-6 at the tamping stations 202, when the support pad 210 is at the bottom position with respect to the plurality of sliders 208. The rotational movement of the dosing disc 206 may be restricted, when the support pad 210 is at the top portion and abuts the plurality of sliders 208 positioned at the tamping stations 202.

In the illustrated embodiment, the support pad 210 may be disposed below the sliders 208-1, 208-2, 208-3, 208-4, 208-5 of the device 106. The support pad 210 may be adapted to be moved in a vertical direction towards the sliders 208-1, 208-2, 208-3, 208-4, 208-5 before initiation of the tamping operation. When the support pad 210 moves in the vertical direction and abuts the sliders 208-1, 208-2, 208-3, 208-4, 208-5, the set of pistons 204-1, 204-2, 204-3, 204-4, 204-5, 204-6 may be moved in the downward direction to perform the tamping operation in the set of dosing chamber 214-1, 214-2, 214-3, 214-4, 214-5 to form the slug for the capsule.

Further, upon completion of the tamping operation, the set of pistons 204-1, 204-2, 204-3, 204-4, 204-5, 204-6 may be moved in the upward direction away from the set of dosing chambers 214-1, 214-2, 214-3, 214-4, 214-5. Subsequently, the support pad 210 may be moved in the downward direction away from the sliders 208-1, 208-2, 208-3, 208-4, 208-5. In an embodiment, the actuation unit 212 may be coupled to the support pad 210. The actuation unit 212 may be adapted to move the support pad 210 towards the at least one slider 208. The actuation unit 212 may move the support pad 208 to abut the at least one slider 208. Constructional and operational details of the actuation unit 212 are explained in detail in the subsequent sections of the present disclosure.

FIG. 6 illustrate a partial cross-sectional view of the device 106 depicting the support pad 210 and the actuation unit 212, according to an embodiment of the present disclosure. FIG. 7 illustrates a perspective view of a drive pulley coupled to a lead-screw mechanism of the actuation unit 212, according to an embodiment of the present disclosure. Referring to FIG. 5, FIG. 7, and FIG. 6, the actuation unit may include, but is not limited to, at least one servo motor 502, at least one driving assembly 504, and a plurality of lead-screw mechanisms 506. In an embodiment, the at least one driving assembly 504 may be coupled to the at least one servo motor 502 and supported on a top plate 602 of the device 106.

Referring to FIG. 6, the top plate 602 may be positioned below the support pad 210. The at least one driving assembly 504 may include, but is not limited to, a gearbox assembly adapted to be coupled to the servo motor 502. Therefore, the at least one driving assembly 504 may interchangeably be referred to as the gearbox assembly 504, without departing from the scope of the present disclosure. The gearbox assembly 504 may be drivably coupled to the servo motor 502 and adapted to be driven by the servo motor 502. The gearbox assembly 504 may be adapted to transfer rotational movement from the servo motor 502 to one of the plurality of lead screw mechanisms 506.

As mentioned earlier, the plurality of lead-screw mechanisms 506 may be drivably coupled to the support pad 210 and the at least one driving assembly 504. The plurality of lead-screw mechanisms 506 may be adapted to linearly move the support pad 210 in the vertical direction towards the at least one slider 208. Referring to FIG. 5, the device 106 may include at least three lead-screw mechanisms 506 adapted to linearly move the support pad 210 in the vertical direction. In the illustrated embodiment, the plurality of lead-screw mechanisms 506 may individually be referred to as a first lead-screw mechanism 506-1, a second lead-screw mechanism 506-2, and a third lead-screw mechanism 506-3, without departing from the scope of the present disclosure.

Referring to FIG. 6 and FIG. 7, in the illustrated embodiment, each of the plurality of lead-screw mechanisms 208 may include a lead screw 604 and a lead nut 606 movably fastened to the lead screw 604. The lead screw 604 may include a first end 604-1 and a second end 604-2 distal to the first end 604-1. The first end 604-1 of the lead screw 604 may be adapted to be coupled to the support pad 210. In the illustrated embodiment, the first end 604-1 of the lead screw 604 may be fastened to the support pad 210 through a coupling member 608. The gearbox assembly 504 may transfer the rotational movement from the servo motor 502 to one of the plurality of lead-screw mechanisms, i.e., the first lead-screw mechanism 506-1. Owing to the rotational movement, the lead screw 604 of the first lead-screw mechanism 506-1 may be linearly moved to move the support pad in the upward direction and the downward direction with respect to the sliders 208.

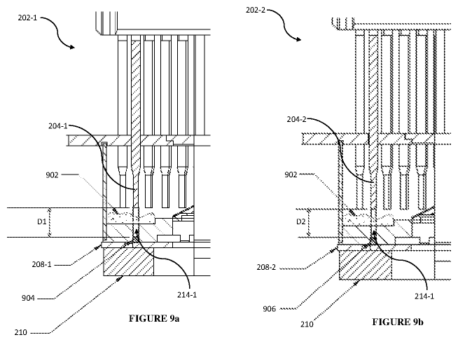

FIG. 8 illustrates a partial top view of the device 106 depicting a pulley mechanism, according to an embodiment of the present disclosure. Referring to FIG. 5, FIG. 6, and FIG. 8, in the illustrated embodiment, the device 106 may include, but is not limited to, a pulley mechanism 802 supported on a base plate 610 disposed on the top plate 602 of the device 106. The pulley mechanism 802 may include, but is not limited to, a drive pulley 612 and a plurality of driven pulleys 804. The drive pulley 612 may be drivably coupled to one of the plurality of lead-screw mechanisms 506. The drive pulley 612 may be adapted to be rotated by one of the plurality of lead-screw mechanisms 506 coupled to the at least one driving assembly 504, i.e., the gearbox assembly 504.

Referring to FIG. 6 and FIG. 7, in the illustrated embodiment, the drive pulley 612 may be drivably coupled to the first lead-screw mechanism 506-1. The drive pulley 612 may be coupled to the lead nut 606 of the first lead-screw mechanism 506-1. The lead nut 606 may be removably fastened to an inner flange 702 of the drive pulley 612 via a plurality of fasteners 704. The lead nut 606 of the first lead-screw mechanism 506-1 may be adapted to be rotated by the gearbox assembly 504. Further, the lead nut 606 may be adapted to rotate the drive pulley 612 of the pulley mechanism 802. Owing to the rotation of the lead nut 606, the lead screw 604 coupled to the lead nut 606 may be linearly moved to displace the support pad 210 in the upward direction and the downward direction.

In an embodiment, the plurality of driven pulleys 804 may be drivably connected to the drive pulley 612 through a belt 806. Each of the plurality of driven pulleys 804 may be adapted to be coupled to a set of lead-screw mechanisms, such as the second lead-screw mechanism 506-2 and the third lead-screw mechanism 506-3, from among the plurality of lead-screw mechanisms 506. The drive pulley 612 may rotate the plurality of driven pulleys 804 through the belt 806 to actuate the set of lead-screw mechanisms 506-2, 506-3 to move the support pad 210 towards the at least one slider 208.

Referring to FIG. 8, in the illustrated embodiment, the plurality of driven pulleys 804 may include a first driven pulley 804-1 and a second driven pulley 804-2. The first driven pulley 804-1 may be drivably coupled to the second lead-screw mechanism 506-2. Similarly, the second driven pulley 804-2 may be drivably coupled to the third lead-screw mechanism 506-3. Further, each of the first driven pulley 804-1 and the second driven pulley 804-2 may be drivably coupled to the drive pulley 612 through the belt 806. Each of the first driven pulley 804-1, the second driven pulley 804-2, and the drive pulley 612 may be circumferentially disposed around a flange 216 of the device 106.

In an embodiment, the pulley mechanism 802 may include, but is not limited to, a first set of rollers 810, a second set of rollers 812, and a pair of idler pulleys 814. Each of the first set of rollers 810, the second set of rollers 812, and the pair of idler pulleys 814 may be drivably connected to the drive pulley 612 and the plurality of driven pulley 804. Referring to FIG. 8, in the illustrated embodiment, the first set of rollers 810 may include a roller 810-1 and a roller 810-2. Each of the roller 810-1 and the roller 810-2 may be embodied as an idler roller for guiding the movement of the belt in the pulley mechanism 802. Each of the roller 810-1 and the roller 810-2 may be positioned between the drive pulley 612 and the second driven pulley 804-2.

Further, the pair of idler pulleys 814 may include a first idler pulley 814-1 and a second idler pulley 814-2. The first idler pulley 814-1 may be positioned between the drive pulley 612 and the first driven pulley 804-1. Similarly, the second idler pulley 814-2 may be positioned between the first driven pulley 804-1 and the second driven pulley 804-2. Further, the second set of rollers 812 may include a roller 812-1 and a roller 812-2. The roller 812-1 may be positioned between the first idler pulley 814-1 and the first driven pulley 804-1. Similarly, the roller 812-2 may be positioned between the first driven pulley 804-1 and the second idler pulley 814-2. Each of the second set of rollers 812 may be embodied as an idler roller for maintaining tension in the belt 806 during the operation of the pulley mechanism 802.

In an embodiment, the device 106 may include, but is not limited to, a controlling unit 508 in communication with the at least one servo motor 502. In an embodiment, the controlling unit 508 may include a processor, memory, modules, and data. The modules and the memory are coupled to the processor. The processor can be a single processing unit or a number of units, all of which could include multiple computing units. The processor may be implemented as one or more microprocessors, microcomputers, microcontrollers, digital signal processors, central processing units, state machines, logic circuitries, and/or any devices that manipulate signals based on operational instructions. Among other capabilities, the processor is configured to fetch and execute computer-readable instructions and data stored in the memory.

The memory may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The modules, amongst other things, include routines, programs, objects, components, data structures, etc., which perform particular tasks or implement data types. The modules may also be implemented as, signal processor(s), state machine(s), logic circuitries, and/or any other device or component that manipulate signals based on operational instructions.

Further, the modules can be implemented in hardware, instructions executed by a processing unit, or by a combination thereof. The processing unit can comprise a computer, a processor, such as the processor, a state machine, a logic array or any other suitable devices capable of processing instructions. The processing unit can be a general-purpose processor which executes instructions to cause the general-purpose processor to perform the required tasks or, the processing unit can be dedicated to perform the required functions. In another aspect of the present disclosure, the modules may be machine-readable instructions (software) which, when executed by a processor/processing unit, perform any of the described functionalities.

In an embodiment, the controlling unit 508 may be configured to determine a position of the at least one dosing chamber 214 of the dosing disc 206 with respect to the at least one piston 204. Based on the determined position, the controlling unit 508 may be configured to rotate the dosing disc 206 to align the at least one dosing chamber 214 with the at least one piston 204. As mentioned earlier, the controlling unit 508 may be configured to rotate the dosing disc 206 to align the at least one dosing chamber 214 with the at least one piston 204.

Further, based on the determined position, the controlling unit 508 may be configured to operate the servo motor 502 to move the support pad 210 in the vertical direction towards the at least one slider 208. In particular, the controlling unit 508 may operate the servo motor 502 to move the support pad 210 in the vertical direction, if the at least one piston 204 aligns with the at least one dosing chamber 214 for performing the tamping operation. As mentioned earlier, the servo motor 502 may be adapted to rotate the lead nut 606 of the first lead-screw mechanism 506-1 which results in the linear movement of the lead screw 604. Further, the lead nut 606 may transfer the rotational movement to the drive pulley 612 which is drivably connected to the plurality of driven pulleys 804 through the belt 806.

The drive pulley 612 may be adapted to rotate the plurality of driven pulleys 804. Owing to such rotation of the plurality of driven pulleys 804, the lead screw 604 of each of the second lead-screw mechanism 506-1 and the third lead-screw mechanism 506-2 may be linearly moved to displace the support pad 210 in the vertical direction. In an embodiment, the drive pulley 612 may be rotated in a clockwise direction and subsequently, the plurality of driven pulleys 804 may also be rotated in the clockwise direction to move the support pad 210 in the vertical direction towards the at least one slider 208. Therefore, owing to the linear movement of the lead screw 604 of each of the plurality of lead-screw mechanisms 506, the support pad 210 may be linearly displaced in the vertical direction towards the at least one slider 208.

In an embodiment, the controlling unit 508 may be configured to operate, based on the determined position, the at least one servo motor 502 to move the support pad 210 in the vertical direction away from the at least one slider 208. In particular, the controlling unit 508 may operate the servo motor 502 to move the support pad 210 away from the at least one slider 208, if the at least one piston 204 retracts from the at least one dosing chamber 214 after completion of the tamping operation. In an embodiment, the drive pulley 612 may be rotated in an anti-clockwise direction and subsequently, the plurality of driven pulleys 804 may also be rotated in the anti-clockwise direction to move the support pad 210 in the vertical direction away from the at least one slider 208. Therefore, owing to the linear movement of the lead screw 604 of each of the plurality of lead-screw mechanisms 506, the support pad 210 may be linearly displaced in the vertical direction away from the at least one slider 208.

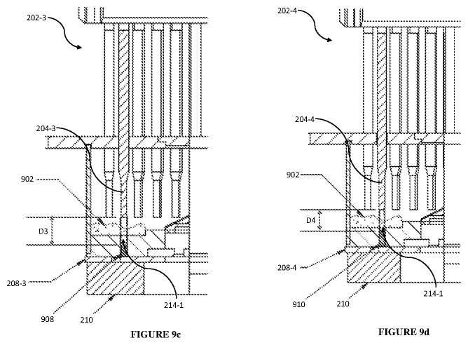

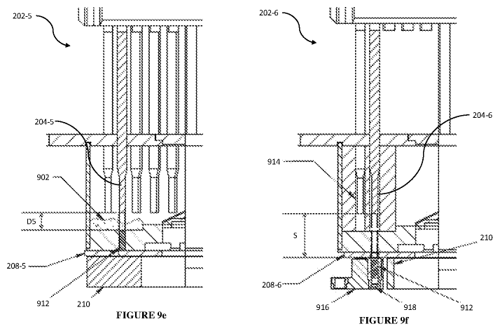

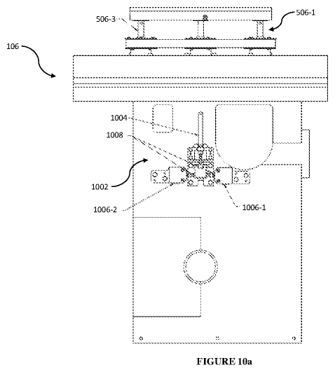

FIGS. 9a-9f illustrate partial perspective views of the device 106 depicting the tamping operation at different tamping stations of the device 106, according to an embodiment of the present disclosure. Referring to FIG. 9a, at the tamping station 202-1, the slider 208-1 may be at the extended position, and the support pad 210 may abut the sliders 208-1. In particular, the plurality of holes 302 of the slider 208-1 may be offset to the set of dosing chambers 214-1 of the dosing disc 206. During the tamping operation, at the tamping station 202-1, the set of pistons 204-1 may be moved in the downward direction to a predefined distance D1 to perform the tamping operation on the material 902 positioned within the set of dosing chambers 214-1. In an example, at the tamping station 202-1, the tamping operation may form a slug 904 having approximately 20% of the material compared to a final slug that is to be inserted in the capsule.

Subsequently, the support pad 210 may be moved away from the sliders 208 after completion of the tamping operation at the tamping station 202-1. Thereafter, the controlling unit 508 may rotate the dosing disc 206 to align the set of dosing chambers 214-1 with the set of pistons 204-2 corresponding to the tamping station 202-2. When the set of dosing chambers 214-1 are aligned with the set of pistons 204-2, the support pad 210 may be moved in the vertical direction towards the sliders 208. Referring to FIG. 9b, at the tamping station 202-2, the set of pistons 204-2 may be moved in the downward direction to a predefined distance D2 to add additional material 902 within the set of dosing chambers 214-1 and subsequently, to perform the tamping operation within the set of dosing chambers 214-1. The predefined distance D2 may be less than the predefined distance D1. In an example, at the tamping station 202-2, the tamping operation may form a slug 906 having approximately 40% of the material compared to a final slug that is to be inserted in the capsule.

Further, the support pad 210 may be moved away from the sliders 208 after completion of the tamping operation at the tamping station 202-2. Subsequently, the controlling unit 508 may rotate the dosing disc 206 to align the set of dosing chambers 214-1 with the set of pistons 204-3 corresponding to the tamping station 202-3. When the set of dosing chambers 214-1 are aligned with the set of pistons 204-3, the support pad 210 may be moved in the vertical direction towards the sliders 208. Referring to FIG. 9c, at the tamping station 202-3, the set of pistons 204-3 may be moved in the downward direction to a predefined distance D3 to add additional material within the set of dosing chambers 214-1 and subsequently, to perform the tamping operation within the set of dosing chambers 214-1. The predefined distance D3 may be less than the predefined distance D1 and the predefined distance D2. In an example, at the tamping station 202-3, the tamping operation may form a slug 908 having approximately 60% of the material compared to a final slug that is to be inserted in the capsule.

As mentioned earlier, before initiating the tamping operation at the tamping station 202-4, the support pad 210 may be moved away from the sliders 208 and subsequently, the dosing disc 206 may be rotated to align the set of dosing chambers 214-1 with the set of pistons 204-4 corresponding to the tamping station 202-4. Referring to FIG. 9d, upon the alignment of the set of dosing chambers 214-1 with the set of pistons 204-4, the support pad 210 may be moved in the vertical direction and abuts the sliders 208. Subsequently, the set of pistons 204-4 may be moved in the downward direction to a predefined distance D4 to add additional material within the set of dosing chambers 214-1 and subsequently, to perform the tamping operation within the set of dosing chambers 214-1. The predefined distance D4 may be less than the predefined distance D1, the predefined distance D2, and the predefined distance D3. In an example, at the tamping station 202-4, the tamping operation may form a slug 910 having approximately 80% of the material compared to a final slug that is to be inserted in the capsule.

Similarly, before initiating the tamping operation at the tamping station 202-5, the support pad 210 may be moved away from the sliders 208 and subsequently, the dosing disc 206 may be rotated to align the set of dosing chambers 214-1 with the set of pistons 204-5 corresponding to the tamping station 202-5. Referring to FIG. 9e, upon the alignment of the set of dosing chambers 214-1 with the set of pistons 204-5, the support pad 210 may be moved in the vertical direction and abuts the sliders 208. Subsequently, the set of pistons 204-5 may be moved in the downward direction to a predefined distance D5 to add additional material within the set of dosing chambers 214-1 and subsequently, to perform the tamping operation within the set of dosing chambers 214-1. The predefined distance D5 may be less than the predefined distance D1, the predefined distance D2, the predefined distance D3, and the predefined distance D4. At the tamping station 202-5, the slug may be completely formed within the set of dosing chambers 214-1. In an example, at the tamping station 202-5, the tamping operation may form the final slug 912 that is to be inserted in the capsule.

Referring to FIG. 9f, the support pad 210 may be moved in the vertical direction away from the sliders 208. Subsequently, the dosing disc 206 may be rotated to align the set of dosing chambers 214-1 with the set of pistons 204-6 corresponding to the tamping station 202-6. Further, the slider 208-6 may be moved to the retracted position such that the plurality of holes 302 of the slider 208-6 may align with the set of dosing chambers 214-1 of the dosing disc 206. Thereafter, the set of pistons 204-6 may be moved in the downward direction within the set of dosing chambers 214-1 to eject the slug from the set of dosing chambers 214-1 and subsequently, through the plurality of holes 302 of the slider 208-6. In the illustrated embodiment, a wiper block 914 and a body holder segment 916 are provided at the tamping station 202-6. The body holder segment 916 may be adapted to hold a body portion 918 of the capsule below the slider 208-6. At least one of the set of pistons 204-6 may be moved in the downward direction, such as a piston stroke S, to insert the final slug 912 in the body portion 918 of the capsule.

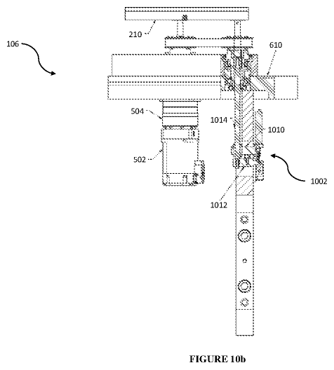

FIGS. 10a and 10b illustrate a rear view and a side view, respectively, of the device 106 depicting a sensing unit, according to an embodiment of the present disclosure. In an embodiment, the device 106 may include a sensing unit 1002 in communication with the controlling unit 508. The sensing unit 1002 may be configured to determine a position of the support pad 210 with respect to the at least one slider 208. The controlling unit 508 may be configured to receive the determined position of the support pad 210 from the sensing unit 1002. Further, the controlling unit 508 may be configured to compare the determined position with a threshold position of the support pad 210 with respect to the at least one slider 208. The controlling unit 508 may be configured to operate, based on the comparison, the at least one servo motor 502 to move the support pad 210 in the vertical direction.

For instance, if the support pad 210 is moved to the top position, the sensing unit 1002 may determine the position of the support pad 210 with respect to the at least one slider 208. Subsequently, the controlling unit 508 may receive the determined position from the sensing unit 1002. The controlling unit 508 may compare the determined position with the threshold position, such as a top threshold position, corresponding to the support pad 210 positioned at the top position with respect to the at least one slider 208. Based on the comparison, if the determined position is equal to the top threshold position, the controlling unit 508 may switch-off the servo motor 502 to restrict the movement of the support pad 210 beyond the top threshold position. Similarly, if the support pad 210 is moved to the bottom position, the sensing unit 1002 may determine the position of the support pad 210 with respect to the at least one slider 208. Subsequently, the controlling unit 508 may receive the determined position from the sensing unit 1002. The controlling unit 508 may compare the determined position with the threshold position, such as a bottom threshold position, corresponding to the support pad 210 positioned at the bottom position with respect to the at least one slider 208. Based on the comparison, if the determined position is equal to the bottom threshold position, the controlling unit 508 may switch-off the servo motor 502 to restrict the movement of the support pad 210 beyond the bottom threshold position.

Referring to FIG. 10a and FIG. 10b, in the illustrated embodiment, the sensing unit 1002 may include, but is not limited to, a position sensor 1004, a pair of limit switches 1006, a pair of actuators 1008, an actuation lever 1012, and a guide rod 1014 coupled to the actuation lever 1012. The position sensor 1004 may be in communication with the controlling unit 508 and adapted to determine the position of the support pad 210 with respect to the at least one slider 208. The controlling unit 508 may receive the position of the support pad 210 from the position sensor 1004. Further, in the illustrated embodiment, the pair of limit switches 106 may include a first limit switch 106-1 and a second limit switch 106-2. The first limit switch 106-1 may be adapted to actuated by one of the pair of actuators 1008, when the support pad 210 moves to the top position with respect to the at least one slider 208. Owing to the actuation of the first limit switch 106-1, the servo motor 502 may switch-off to restrict the movement of the support pad 210 beyond a top threshold position with respect to the at least one slider 208.

Similarly, the second limit switch 106-2 may be adapted to be actuated by one of the pair of actuators 1008, when the support pad 210 moves to the bottom position with respect to the at least one slider 208. Owing to the actuation of the second limit switch 106-2, the servo motor 502 may switch-off to restrict the movement of the support pad 210 beyond a bottom threshold position. The pair of limit switches 106 may be adapted to be operated to switch-off the servo motor 502 based on the movement of the support pad 210 in the vertical direction. Further, the guide rod 1014 may be adapted to be linearly moved in the vertical direction based on the movement of the support pad 210. The guide rod 1014 may be adapted to displace the actuation rod 1012 based on the movement of the support pad 210 to actuate the pair of limit switches. Subsequently, based on the actuation of one of the pair limit switches, operation of the servo motor 502 may be controlled and accordingly, the movement of the support pad 210 in the vertical direction is restricted beyond the threshold distance.

As would be gathered, the present disclosure offers the device 106 for performing the tamping operation in the capsule filling machine 100. The device 106 may include the support pad 210 adapted to abut the sliders 208 during the tamping operation. The support pad 210 may be adapted to distribute the tamping force applied by the at least one piston 204 on the material during the tamping operation. In particular, support pad 210 may be adapted to absorb the tamping force applied by the at least one piston 204 during the tamping operation. Owing to the distribution of the tamping force by the support pad 210, spillage of the material during the tamping operation is substantially eliminated in the device 106. This results in a substantial reduction in overall wastage of the material, i.e., the drug, to be filled in the capsule. Further, owing to substantial elimination of spillage of the material, the overall service life of the device 106 and the capsule filling machine is substantially increased. Therefore, the device 106 of the present disclosure are efficient, durable, flexible in implementation, cost-effective, and convenient.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A device for performing tamping operation in a capsule filling machine, the device comprising:
a dosing disc having at least one dosing chamber adapted to be filled with a material which is to be filled in a capsule;
at least one piston adapted to be moved within the at least one dosing chamber to perform the tamping operation on the material to form a slug, wherein the at least one piston applies a tamping force on the material filled within the at least one dosing chamber;
at least one slider disposed below the dosing disc and adapted to abut the dosing disc, wherein the at least one slider is adapted to support the material within the at least one dosing chamber to perform the tamping operation;
a support pad movably disposed beneath the at least one slider and adapted to be moved towards the at least one slider, wherein the support pad is adapted to abut the at least one slider to distribute the tamping force applied by the at least one piston on the material; and
an actuation unit coupled to the support pad and adapted to move the support pad towards the at least one slider, wherein the actuation unit moves the support pad to abut the at least one slider.

2. The device of claim 1, wherein the at least one piston is adapted to reciprocate to a pre-defined distance within the at least one dosing chamber.

3. The device of claim 1, wherein the at least one slider is movably disposed below the dosing disc and includes a plurality of holes, wherein each of the plurality of holes offsets from the at least one dosing chamber of the dosing disc.

4. The device of claim 3, wherein the at least one slider is adapted to be moved between a retracted position and an extended position with respect to a central axis of the dosing disc, wherein:
in the extended position, each of the plurality of holes offsets from the at least one dosing chamber of the dosing disc; and
in the retracted position, at least one of the plurality of holes aligns with the at least one dosing chamber of the dosing disc, wherein the slug is ejected from the at least one dosing chamber through one of the plurality of holes.

5. The device of claim 4, wherein the at least one slider is adapted to remain in the extended position when the at least one piston moves within the at least one dosing chamber to perform the tamping operation.

6. The device of claim 1, wherein the actuation unit comprises:
at least one servo motor;
at least one driving assembly coupled to the at least one servo motor and supported on a top plate of the device, wherein the top plate is positioned below the support pad; and
a plurality of lead-screw mechanisms drivably coupled to the support pad and the at least one driving assembly, wherein the plurality of lead-screw mechanisms is adapted to linearly move the support pad in a vertical direction towards the at least one slider.

7. The device of claim 6 further comprising:
a pulley mechanism supported on a base plate disposed on the top plate of the device, wherein the pulley mechanism comprises:
a drive pulley drivably coupled to one of the plurality of lead-screw mechanisms, wherein the drive pulley is adapted to be rotated by one of the plurality of lead-screw mechanisms coupled to the at least one driving assembly;
a plurality of driven pulleys drivably connected to the drive pulley through a belt, wherein each of the plurality of driven pulleys is adapted to be coupled to a set of lead-screw mechanisms from among the plurality of lead-screw mechanisms;
wherein the drive pulley rotates the plurality of driven pulleys through the belt to actuate the set of lead-screw mechanisms to move the support pad towards the at least one slider.

8. The device of claim 6 further comprising a controlling unit in communication with the at least one servo motor and configured to:
determine a position of the at least one dosing chamber of the dosing disc with respect to the at least one piston;
operate, based on the determined position, the at least one servo motor to move the support pad in the vertical direction towards the at least one slider if the at least one piston aligns with the at least one dosing chamber for performing the tamping operation; and
operate, based on the determined position, the at least one servo motor to move the support pad in the vertical direction away from the at least one slider if the at least one piston retracts from the at least one dosing chamber after completion of the tamping operation.

9. The device of claim 8 further comprising a sensing unit in communication with the controlling unit and configured to determine a position of the support pad with respect to the at least one slider, wherein the controlling unit is configured to:
receive the determined position of the support pad from the sensing unit;
compare the determined position with a threshold position of the support pad with respect to the at least one slider; and
operate, based on comparison, the at least one servo motor to move the support pad in the vertical direction.

10. The device of claim 1, wherein the dosing disc is adapted to rotate about a central axis of the dosing disc to align at least one dosing chamber with at least one piston when the support pad is at a bottom position with respect to the at least one slider.
